(19) United States
(12) Patent Application Publication
(10) Pub. No.: US 2010/0220744 A1
(43) Pub. Date: Sep. 2, 2010

(54) INTELLIGENT START COUPLER FOR TIME TRIGGERED COMMUNICATION PROTOCOL AND METHOD FOR COMMUNICATING BETWEEN NODES WITHIN A NETWORK USING A TIME TRIGGER PROTOCOL

(75) Inventors: Joern Ungermann, Aachen (DE); Andries Van Wageningen, Wijlre (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/440,414

(22) PCT Filed: Aug. 28, 2007
(86) PCT No.: PCT/IB2007/053444

§ 371 Date: Mar. 6, 2009

(30) Foreign Application Priority Data
Sep. 6, 2006 (EP) 06120214.9

(51) Int. Cl. H04L 12/43

(52) U.S. Cl. 370/458

(57) ABSTRACT

This invention relates to a star coupler connected to a plurality of nodes within a network using a time triggered protocol on a time slot basis. The invention further relates to a network including a cluster having at least one node. Further, the invention relates to a method for communication between nodes within a network using a time trigger protocol. To provide a star coupler, which is able to increase the bandwidth and to communicate with low propagation delay for communicating the relevant data it is proposed to provide a star coupler (11) comprising a switch (12) having a plurality of input branches and output branches, wherein a switch controller (13) is provided for controlling the switch (12), further comprising means (14, 15) for deriving knowledge about the protocol timing, which knowledge is used for selectively forward data in a certain time slot to at least one predetermined output.

This invention relates to a star-coupler connected to a plurality of nodes within a network using a time triggered protocol on a time slot basis. The invention further relates to a network including a cluster, wherein a cluster includes at least one node. Further, the invention relates to a method for communication between nodes within a network using a time trigger protocol.

Dependable automate communication networks typical relay on time triggered communication protocols like TTP/C of Flex-Ray based on broadcast methods according to a predetermined TDMA scene. Time triggered protocols are proposed for distributing real communication systems as used in, for example the automobile industry. Communication protocols of this kind are described in “FlexRay—A Communication System for advanced automate Control Systems”, SEA world congress 2001.

In these systems, the media access protocol is based on a time triggered multiplex method, such as TDMA (Time Divisional Multiple Access) with a steady communication time schedule, which is defined in advance during system designs. This communication schedule defines for each communication node the point in times at which it may transmit data within a communication cycle. Such networks may include a plurality of different communication clusters. Each cluster includes at least one node, which are interconnected in various topologies. For this invention, topologies containing an active star coupler are relevant.

An active star coupler is a device to which multiple nodes are connected. The star coupler generally forwards information received on one of its input branches to all other connected nodes or sub-nets. In case of multiple simultaneously incoming data streams, generally, the first that comes is served. This concept may be combined with a central bus guardian.

A central bus guardian generally contains a protocol engine of reduced functionality to derive a communication cluster schedule. The central bus guardian implements various protective measurements to prevent faults for interfering a normal communication. It generally only forwards information of a predetermined branch during each time slot of the communication schedule, thereby protecting the channel from illicit communication. The bus guardian has an independent time base and is equipped with a scheduler, which allows right access to the medium only during time slots reserved for communication node during short tolerance areas before and after these time slots. If the bus includes a central bus guardian, it establishes a communication node that is attempting to access the data bus outside the time period reserved for it, the central bus guardian stops this access and reports the state and permanently blocks further accesses by this communication node. Thus, it ensures a fail silent property of a communication node. By using central bus guardians a single defective node, also known as “babbling idiot”, which is constantly transmitting outside its allocated time slot may be blocked.

Conventional star coupler concepts are provided for application in a single network cluster. A star coupler forwards data on a physical level, whereby all connected nodes receive the same data at any output branch of the network. From a protocol point of view, there is no difference between a bus or a star topology. Therefore, the total available bandwidth in the cluster is restricted by what the time triggered protocol allows.

However, next generation high speed protocols will allow higher bandwidths, but will require additional effort in standardization, development and field tests. A cluster with high bandwidth facilities serving more nodes will in many cases have a higher probability of faults caused by the higher transmission speeds and will be more vulnerable for fault propagation than a cluster with lower bandwidths facilities serving less nodes.

Another seemingly easy solution to this need in bandwidth is to define separate clusters and to interconnect these clusters by use of gateways. However, conventional gateways must also use complex algorithms to synchronize the attached time triggered communication clusters and even then a significantly increased propagation delay of communicated messages must be accepted. Currently, no time-critical communication for safety-relevant applications may pass a gateway due to these limitations. Thus, the application of a conventional gateway within automotive networks, in which safety-relevant applications are operated is not possible.

Known star coupler concepts are able to disconnect one or more of the connected branches from the rest of the cluster, but do not support disjunctive operation of individual branches parallel.

US2005/0094674 A1 describes an active star coupler, in which a plurality of communication nodes is connected via point to point connections. The data transmitted by a communication node is passed to all other communication nodes with aid of the distribution unit in the star coupler.

Due to the bandwidth and the delay limitations, it is an object of the present invention to provide a star coupler, which is able to increase the bandwidth and to communicate with low propagation delay for communicating the relevant data.

The object of the present invention is solved by the features of the independent claims.

In particular, the object is solved by a star coupler which is connected to a plurality of nodes within a network using a time triggered protocol and a time slot basis, wherein the star coupler comprises a switch having a plurality of input branches and output branches, wherein a switch controller is controlling the switch, further comprising a mean for the arriving knowledge about the protocol timing, which knowledge is used for selectively forward data in certain time slots to at least one predetermined output.

The invention is based on the thought to provide a so-called switched star coupler or intelligent star coupler, which may be easily configured such that it distributes incoming data at any port to all other ports. The inventive intelligent star coupler includes all features of a conventional active star coupler, e.g. like synchronized nodes and the appliance of multiple redundant couplers for fault tolerant reasons.

By use of the inventive switched intelligent star coupler, a higher total available bandwidth is provided because parts of the communication flow can be forwarded in parallel without interfering each other. It can also offer a better protection against fault propagation because the communication flow can be separated and incoming data can be selectively forwarded.

The object is also solved by a method for communicating between nodes within a network using a time triggered protocol on a time slot basis, comprising the steps of: receiving input data at an input branch of a star coupler; decoding communication elements within the data and deriving a communication cluster schedule from the communication elements; providing the communication cluster schedule to a switch controller and controlling a switch having a plurality of input branches and output branches on a time slot basis, wherein the switch may depending on the switch controller connect each input branch to one or multiple output branches, wherein the plurality of the input branches may be active within the same time slot.

Further advantageous implementations and embodiments of the invention are set forth in the respective sub claims.

The invention provides an intelligent active star coupler increasing the available bandwidth of a cluster without requiring modifications in the hardware or software of other involved components. Thus, it is possible to allocate more applications to a single communication cluster without having to resort complicated solutions over different communications domains and to interconnect these with expansive gateways. Further, the propagation delays are decreased by not using any gateways.

According to this invention, a switch is added to the active star coupler, which is controlled by a switch controller. The switch controller receives information from a protocol engine and from a communication schedule unit. The information contains at which time slots which input branches are connected to which output branches. Thereby, the data throughput of the communication cluster is dramatically increased up to nearly n-times, if n-branches are attached to the intelligent star coupler. Further, the invention is completely backward compatible to the communication cluster. It provides also an increased protection for the communication media and is thereby fully usable for safety relevant application. It further solves the difficult problem of connecting multiple time triggered clusters to one another in an easy and intuitive way by logically combining the different clusters into a single one. This is especially applicable for the FlexRay protocol.

An intelligent star coupler is nearly including all functionality contained in a central bus guardian. Thus, the inventive star coupler may be integrated into a central bus guardian. However, it may operate perfectly alone, or even replace a central bus guardian.

One of the most important components of the inventive star coupler is that the star coupler includes means for deriving the position within a communication schedule. Further, it should operate in a broadcast mode (first come first serve) before a communication schedule is established. In particular it is advantageous when the star coupler could derive the communication cluster schedule faster than other nodes in the cluster, but this is not a necessary feature.

It is further advantageous to switch the switch depending on the time slot number. However, some protocols have additional identifications like a cycle number, which may be used to have different connections of the input branches to the output branches within the same time slot but in different cycles. Thus, the switching of the connections may be different in different cycle numbers.

The invention is described in detail below with reference to the accompanying schematic drawings, wherein:

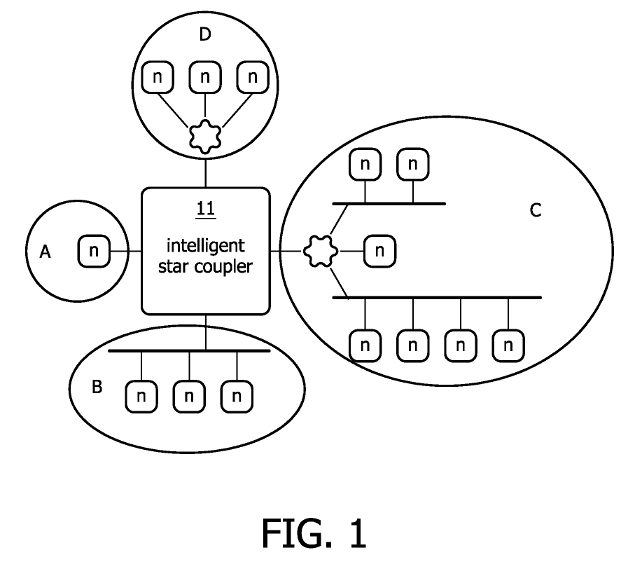

FIG. 1 shows a network including a plurality of sub-nets within a cluster as used in invention;

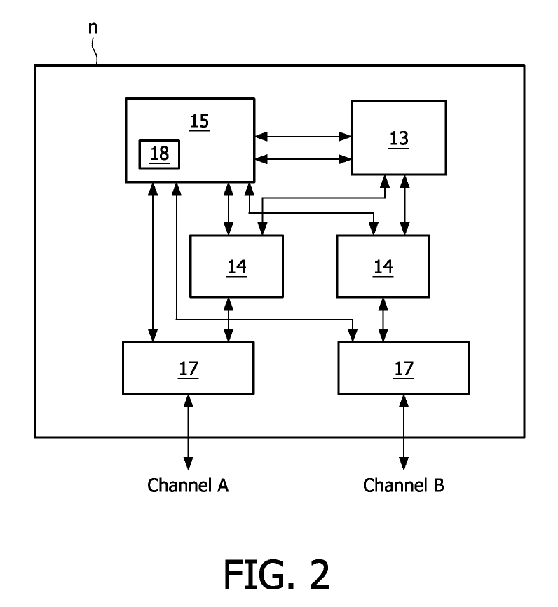

FIG. 2 shows a configuration of a node according to the invention;

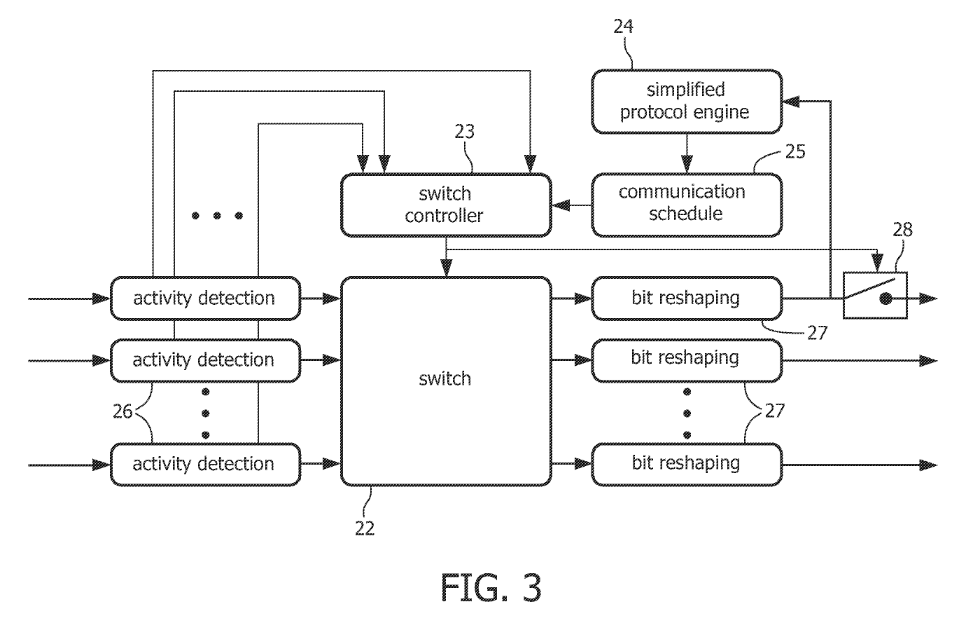

FIG. 3 shows an embodiment of an intelligent star coupler architecture according to the invention;

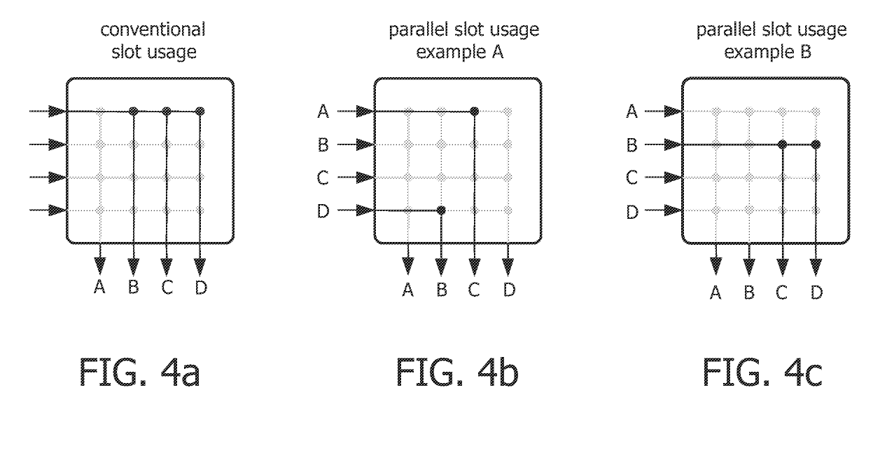

FIGS. 4a to 4c show examples for a configuration schedule of the switch;

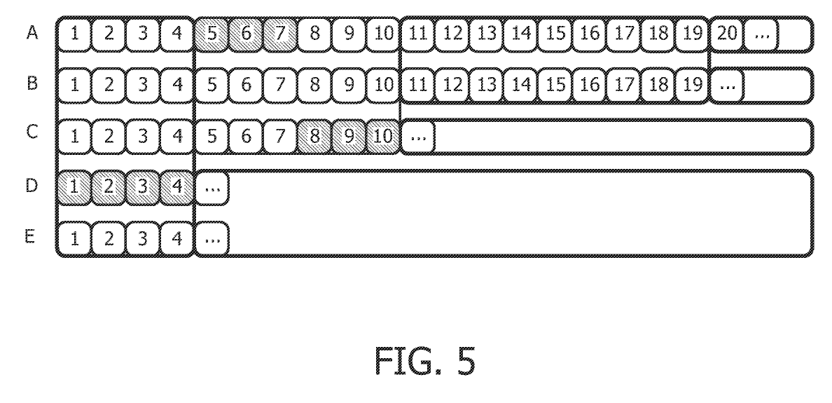

FIG. 5 shows a dynamic protocol segment solution according to the invention;

FIG. 1 illustrates a network as used in the present invention. The cluster illustrated in FIG. 1 is portioned into a number of sub-nets (A-D), each of them be supported by a passive bus or by an active star-coupler in a connection topology. These sub-nets are interconnected by the intelligent star-coupler 11, which is provided for inter sub-net communication. Several sub-nets A-D are connected to the intelligent star-coupler 11. The sub-nets A-D have different topologies. In particular, it is depicted that sub-net B includes a passive bus. Sub-net C comprises a hybrid topology including a star coupler and a passive bus topology. Sub-net D includes an active star topology, wherein sub-net A includes a single node only. Naturally, an arbitrary number of sub-nets can be connected. Depending on the protocol used in the network, it may be possible to restrict the topology that only one sub-net may contain a single conventional active star coupler.

With reference to FIG. 2, a node n used in such sub-net is described in more detail. A typical fault-tolerant time-triggered network consists of two or more communication channels, to which nodes are connected. Each of those nodes n consists of a bus driver 17, a communication controller 15 and eventually a bus guardian device 14 for each bus driver and an application host 13. The bus driver 17 transmits the bits and bytes that the communication controller 15 provides onto its connected channels and in turn provides the communication controller 15 with the information it receives from the channel Channel A, B. The communication controller 15 is connected to both channels and delivers relevant data to the host application 13 and receives data from it that it, in turn, assembles to frames and delivers to the bus driver 17. The realization of a node within the sub-nets is not relevant for the invention. The configuration of such node is explained only for getting a better overview for the application. The invention is not limited or restricted by the presence or absence of parts within the described node. The communication controller 15 contains a so-called protocol engine 18, which provides a node n with the facilities for the layer-2 access protocol. Most relevant for this invention is the facility to access the medium with a pre-determined TDMA scheme, or communication schedule. The communication schedule for each node n inside a cluster has to be configured such that no conflict between the nodes n occurs when transmitting data on the network. The bus guardian 14 is a device with an independent set of configuration data that enables the transmission on the bus only during those slots, which are specified by the configuration set. The host application 13 contains the data source and sink and is generally not concerned with the protocol activity. Only decisions that the communication controller 15 cannot do alone are made by the host application 13.

In many cases a conventional active star coupler connects the nodes n in a cluster. Its purpose is to improve the signal quality on the communication line, compared to the situation where nodes n are connected via a passive bus. A conventional active star coupler allows connecting more nodes n in a single cluster than a passive bus. It further offers the possibility to disconnect malfunctioning nodes n from the cluster in order to limit the propagation of faults through the cluster. A conventional star coupler works on physical level forwarding data from one selected input port to all output ports at a time. On protocol level, it does not show a difference between a bus and a star topology.

Synchronization between the nodes n is a pre-requisite to enable time-triggered TDMA based access to the network. Every node n has its own clock, for which the time base can differ from the other nodes n, although they are originally intended to be equal, caused by temperature and voltage fluctuations and production tolerance.

The communication controller 15 within each node n includes a synchronization mechanism, wherein nodes n listen to their attached channels and can adapt to the synchronization or influence a common clock rate and offset.

Network startup in a single cluster is handled by so called cold-starting nodes, whereof one initiates the communication cycles in a cluster and others respond. This node is selected either by configuration or by some algorithm, that determines which of several potential nodes performs the startup. This algorithm generally consists of transmitting frames or similar constructs over the attached channels, whenever no existing schedule could be detected. The communication controller 15 of a cold-starting node thereby has to listen to all attached channels and has to transmit its startup data on all attached potentially redundant channels at the same time. There is only one single control logic 18 for the startup inside the communication controller 15 for all attached channels. Each node within the cluster listens to its attached channels. If it receives specific frames or similar constructs indicating a startup it will adopt the timing scheme from the observed communication and integrate into the system.

A central bus guardian (not illustrated) may be added to such a cluster. The cluster is then partitioned into single nodes or sub-nets, which are in turn connected to the central bus guardian. This central bus guardian is preconfigured with information about the communication schedule of its cluster with respect to which of its branches may transmit data to the other branches during which time slot of the communication schedule. Some implementations also allow the bus guardian to gain the knowledge regarding which of its pins is connected to which branch in an initial learning phase to prevent misconnections during installations. The central bus guardian also contains logic to determine the communication schedule from information received from its branches. This normally is a protocol engine with reduced functionality in some respects and added functionality with respect to protecting against different types of faults (e.g. protection against illicit startup attempts from branches that cannot do so, protection against transmissions longer than anything possibly legal, etc.).

According to FIG. 3, an intelligent star coupler architecture according to the present invention is illustrated. The intelligent star coupler includes a switch 12 having a plurality of input branches and a plurality of output branches. The switch 12 is connected to a switch controller 13 controlling the connections from the input branches to the output branches within the switch 12. Further, there is a simplified protocol engine 14 decoding communication elements, wherein the communication elements are series of signals defined in the protocol specification. For the FlexRay protocol the communication elements include, e.g. a wakeup pattern, the collision avoidance symbol, synchronization and startup frames and data frames. The cluster has a preconfigured communication schedule consisting of various segments which are partitioned into slots, etc. In FlexRay a time slot can be assigned to only a single node, whereas the switch 22 enables multiple nodes to transmit within a time slot. This communication schedule must be preconfigured into the various nodes and the intelligent star coupler 11. During the cluster startup, the nodes agree upon a cycles start and thereby basically on the position of the slots in time. The intelligent star coupler has the a priori knowledge of which branch is to be connected to which other branches for any given time slot, but it does not have the knowledge of which time slot it currently is. Here the protocol engine 24 comes into the picture, which decodes communication elements and therefrom derives the current position within the communication schedule and offers this information to the communication schedule unit 25 and the switch controller 23, which then can configure the switch 22 accordingly.

Based on the decoded communication elements, the simplified protocol engine 24 constantly derives the current position in the communication schedule (i.e. which slot it currently is). This information is provided to the communication schedule 25 unit, which contains for each time slot a matrix defining the required connections of the input branches to the one or more output branches. The communication schedule unit 25 provides this matrix and the appropriate switching times to the switch controller 23. The matrix includes which inputs are connected to one or a plurality of output branches for a predetermined time slot. Additionally, in the input branches, there are activity detection units 26. These activity detection units 26 are used in particularly during the time period in which no communication cluster schedule has been established. During that time, the activity detection units 26 monitor the input branches and provide an activity information to the switch controller 23 for controlling the switch 22. Further, in the output branches there are bit-reshaping units 27, which are explained below.

An intelligent star coupler 11 is based on conventional star coupler, including additional means 24, 25 for the deriving knowledge about the protocol timing and having thus the ability to selectively forward messages sent in a certain time slot to a specific output branch. In contrast to a conventional active star coupler, more than a single input branch may be active during a single time slot. This feature multiplies the available bandwidth without reducing the protection provided by a conventional active star coupler.

As depicted in FIG. 3, the data stream is highlighted by the bold arrows. On the left side of the star coupler 11 the input lines are connected via the arrows to the right hand side symbolize the data connection to the output branches. The various components of the switch 22 are now described in more detail. The activity detection unit 26 is provided at the input side of the intelligent star coupler 11. While the intelligent star coupler 11 is not yet synchronized to the communication schedule the activity detection unit 26 may provide a degraded service in a “first come first serve” fashion. Which ever input branch is activated first is forwarded to all output branches. These activity detection units 26 may also be used during the FlexRay dynamic protocol segment. However, the activity detection unit 26 is not an essential feature since there could be further means for managing the time period, in which the intelligent star coupler 11 is not yet synchronized to the communication schedule.

The switch controller 23 controls the switch 22 and thereby determines which input branches of the switch 22 are connected to which output branches during a given time slot. The switch controller 23 receives information both from the activity detecting units 26 and from the communication schedule unit 25. As mentioned above while the communication schedule is not yet established, the switch controller 23 uses the activity detecting units 26 solely for configuring the switch 22, while as soon as a communication schedule is established, it disregards the activity detecting units 26.

The protocol engine 24 of the intelligent active star coupler 11 should generally receive all synchronization information exchanged by the sub-nets connected to the input branches (i.e. sync/startup frames), as should all other communication controllers 15 of the nodes n within sub-nets. So, whenever such a frame is being transmitted in one of the sub-nets this frame will be forwarded to all other sub-nets except for its own sub-net since at the one hand it has already been transmitted there by the original node and at the second hand this will cause interference. The protocol engine 24 is attached to one output branch in this implementation form only, so by just not transmitting the sync frame to this output the protocol engine 24 would miss out the frame. To also enable it to recieve that sync frame the additional switch 28 has been added to be able to forward the sync frame to the protocol engine 24, but to prevent it from being actually transmitted into the sub-net it originated from.

An alternative (not illustrated) to this construct would be to add an additional output to the switch 22, thereby increasing the switch 22 from n×n to an n×(n+1) switch. This additional output is then connected to the simplified protocol engine 24 with or without an additional bit reshaping unit.

The switch 22 can be arbitrarily connect each input branch to one or multiple output branches. However, it cannot necessarily connect multiple inputs to one output line. The preferred implementation of the switch 22 is an analogous crossbar switch. Alternatively, different implementations can be used. Such different switch implementations will be explained below. However, the propagation delay used by different switch architectures must be kept minimal since the end-to-end propagation delay in a TDMA communication cluster directly influences effectively usable bandwidth.

The bit reshaping units 27 use appropriate algorithms to regenerate the communication elements that were distorted by typical physical layer effects. These algorithms are for example the decoding of the communication elements via the normal decoding algorithm of the protocol (oversampling, majority voting and bit strobing for FlexRay) followed by an encoding of the resulting bit stream. In effect, the signal is converted back to digital form and then clearly regenerated. The typical physical layer effects influencing the bit stream are for example electromagnetic emissions, asymmetries in the LOW/HIGH and HIGH/LOW transitions within the transceivers, reflections, etc. This bit reshaping prevents the accumulation of asymmetries possible if a signal travels through multiple star couplers. The bit-reshaping units 27 are optional components. Thus, the intelligent star coupler 11 may be operated also without a bit reshaping unit 27. Further, the bit-reshaping units 27 may also be situated before passing through the switch 22 or even before the activity detection unit 26. In particular, clocked switch implementation would benefit from the bit reshaping unit, being situated before the switch.

The simplified protocol engine 24 is a protocol depending unit, which is able to decode communication elements and to derive the synchronization of the cluster from this. The protocol engine 24 generally can use a standard protocol IP but also be reduced in functionality to reflect the fact that it need not actually send data and is connected to only a single channel. The protocol engine 24 supplies the communication schedule unit 25 with the necessary information about which time slot the protocol currently is in. In particular, the protocol engine 24 is connected to only one output branch. However, this is sufficient since during the time in which no cluster communication schedule is available or in which the cluster is not synchronized, the switch is working in that way that a first coming input branch is connected to all output branches. Thus, also the first output branch will receive the data received on one of the input branches.

The communication schedule unit 25 contains the communication schedule matrix including which input branch must be connected to which output branch during which time slot. It may even indicate that during certain time slots, the activity detection shall be used again. This enables dynamic slot usage in dedicated segments of the schedule that do not need to be protected. The data stream may be observed or monitored also before the reshaping unit 27.

In the following the switch configuration will be explained referring to FIGS. 4a to 4c. The configuration of the cross point matrix may be changed for every communication time slot. FIGS. 4a to 4c indicate examples of configuration schedules for a 4×4 intelligent star coupler. In FIG. 4a, a matrix is shown according to a conventional slot usage, where during the specific time slot all data received on the input branch from sub-net A is forwarded to all other output branches of the sub-nets B, C and D. The example of FIG. 4a is valid for the time before synchronization is reached within a cluster.

FIG. 4b shows how connecting sub-net A with sub-net C and in parallel the connecting of sub-net D with sub-net B. Thus, the available bandwidth in this time slot is actively doubled. It could easily be recognized that two input branches are active within the same time slot in parallel. Such parallel activity of more than one input branch is not possible with a conventional star coupler.

The example shown in FIG. 4c illustrates how sub-nets can be completely disconnected from another sub-net during a specific time slot. According to the example shown in FIG. 4c, the sub-net A can communicate internally something that is not of interest for the other sub-nets while sub-net B shares information with the sub-nets C and D. Thus, the available bandwidth within this time slot is effectively doubled.

This configuration allows optimal bandwidth usage in each time slot by providing the information to those sub-nets that require them. In the extreme case the intelligent star coupler 11 can decouple all sub-nets A-D completely from one another to achieve a theoretical maximum of n-times the normal bandwidth with n attached sub-nets.

This description handled up to now only a single communication channel. However, the invention can naturally also be used for communication systems that use multiple channels, since it does not impose any requirements on these channels. It can be used both in single channel or multiple channel systems. Should a multiple channel system be used, an intelligent star coupler may be used on only a subset of the available channels or all channels. Theses intelligent star couplers need not communicate with one another and need not be modified to accommodate for multiple channel usage. However, in case of multiple channels only the switch 22 and maybe the activity detection units 26 and bit reshaping units 27 are multiple realized, since these multiple components could be controlled by only one protocol engine 24, one communication schedule unit 25 and one switch controller 26. In particular, these three components 24, 25 and 23 may be combined within one circuit block for single and for multiple channels.

Therefore, the invention may be transparently integrated into existing systems and does not introduce additional single point of failures.

As mentioned above a number of different switch implementations may be used for the intelligent star coupler, which are now described in a more detailed way. The preferred solution is the analogue crossbar, but the invention explicitly also encompasses different implementations of the switch.

The architecture depicted in FIG. 3 illustrates an analogue crossbar switch with bit reshaping at the output branches. This architecture produces a clearly regenerated output signal with minimal propagation delay, thereby not effecting the communication cluster precision. Naturally the analogue crossbar switch may also be assembled from smaller 2×2 switches.

Alternatively, a digital crossbar may be used. A digital crossbar has an input clock and aligns its output values only at clock edges to its inputs. To achieve a good signal quality on the output lines this clock must be faster than the bit-clock. For the FlexRay protocol, a clock with more than 8-times over sampling is the minimum (FlexRay sample clock speed). Such a digital crossbar switch might benefit greatly from positioning the bit-reshaping unit before the switch. Generating bits before the switch reduces the need of feeding over sampled values through the switch. A small FIFO of small depth for generated bit values is sufficient so that the switch can be clocked with only the bit-clock speed, thereby reducing implementation costs. However, such a solution might interfere with the clock correction algorithms of the protocol in question, thereby worsening the precision and thereby effectively reducing the available bandwidth. The effects can be calculated though and configured into the cluster by increasing the safety intervals in between transmissions, so that no functional degradation will occur except for the slightly reduced available bandwidth.

Further, memory switches may be used, wherein the description for the digital crossbar can principally also be applied to a single memory switch. Instead of a crossbar and FIFOs, all samples are written into a central memory. Again, by putting the bit-reshaping units before the switch, the load on memory accesses can be reduced by an order of magnitude and thereby reduce implementation cost.

The inventive star coupler may be especially be used in combination with the FlexRay protocol. The FlexRay protocol uses a dynamic protocol segment for non-safety-relevant communication. Therein, a dynamic arbitration scheme is used for using the available bandwidth more efficiently. Slots without transmission are shortened to the bare minimum while slots with transmissions are fitted tightly around the transmitted frame. Thus, the slot length is not equal for all slots. Further, it is not know in advance, when a slot starts and when it ends.

The use of the inventive star coupler for the dynamic protocol segment generally complicates the switching of the switch 22, since the slots are of arbitrary length. To make things even worse, the slot counting in the nodes is based on the assumption that all nodes see the same information on the attached signal lines. If the sub-nets are decoupled their slotting will quickly get out of sync, preventing intercommunication. Therefore, this dynamic protocol segment must be handled differently from the static protocol segment of the communication cycle, so an improved functionality of the intelligent star coupler shall also be implemented here. For solving the problem to use the inventive star coupler also in the dynamic protocol segment three different solutions to the problem of the dynamic segment are given. Each solution is adding more functionality to the intelligent star coupler.

At first it should be guaranteed to still be able to communicate in the dynamic protocol segment when using the inventive intelligent star coupler 11. Therefore, it is easiest to just replicate the behaviour of a conventional active star coupler for this dynamic protocol segment. That means for the dynamic protocol segment the intelligent star coupler will act as a conventional star coupler. Whichever sub-net first starts a transmission is forwarded to the other sub-nets. Using the activity detector units 26 this is easily implemented. As stated, this solution has the same behaviour as a conventional active star coupler and therefore no advantages for the dynamic protocol segment.

Secondly, since the intelligent star coupler contains a simplified protocol engine 24, it may impose a certain degree of protection. It can derive like all other nodes within the cluster the current time slot from the observed traffic and therefore the protocol engine 24 may allow only certain sub-nets transmission within this time slot. However, this transmission must still be forwarded to all other sub-nets. Should a sub-net try a transmission during a time slot within which it does not have the permission, its transmission will be contained to this sub-net. This sub-net is then likely desynchronized from the other sub-nets due to this fault-containment. Therefore, this sub-net can be optionally ignored and blocked for the remainder of this dynamic protocol segment. In the next communication cycle, this sub-net may or may not be allowed transmission again depending on different well-known algorithms (e.g. error counter, etc.).

To provide an improved bandwidth also in the dynamic protocol segment a parallel usage of the switch to a certain degree is proposed and thereby an effective bandwidth increase can be achieved. The intelligent star coupler behaves first as described in one of the two previous solutions. Its simplified protocol engine 24 is aligned to the cluster and knows within which slot the cluster currently is. At defined time slot boundaries, the star coupler 11 may then decouple certain sub-nets, thereby creating synchronized sub-clusters. These decoupled sub-clusters remain then unmodified until the end of the dynamic protocol segment. The sub-cluster, to which the simplified protocol engine 24 of the intelligent star coupler is attached to can be further sub-divided at succeeding slot boundaries. Within a sub-cluster, whichever sub-net transmits first is forwarded to all other sub-nets of this sub-cluster. If a sub-cluster consists of only a single sub-net, no forwarding to other sub-nets is necessary. This sub-net can then use the remainder of the dynamic protocol segment efficiently for internal communication within the sub-net. The sub-cluster to which the simplified protocol engine of the intelligent star coupler is attached may provide additional protection (blocking nodes, keeping synchronization) as described above.

This solution for using the inventive star coupler also for the dynamic protocol segment will be explained in more detail with reference to FIG. 5 FIG. 5 illustrates a dynamic segment bandwidth increase example. Slots that the intelligent star coupler 11 knows about are shown numbered. Communicating sub-clusters are contained in a heavy box. Slots with protection are hatched. Within these slots only the hatched sub-net may transmit. FIG. 5 provides an example of an intelligent star coupler 11 with five sub-nets A-E. The simplified protocol engine 24 of the intelligent star coupler 11 is attached to sub-net A. During the first four slots of the dynamic protocol segment, the intelligent star coupler 11 allows only sub-net D to transmit frames (the slots of sub-net D are hatched). This protects these slots from erroneous transmissions from the other sub-nets. The input from sub-net D is forwarded to all other sub-nets. From slot five on, sub-nets D and E are decoupled from the other sub-nets A-C and coupled together. Any transmission of sub-nets D and E is forwarded to only the other in a first come first served fashion for the remainder of the dynamic protocol segment. Thus, the switch 22 is divided into two parts by the switch controller 23. The upper part is handling sub-nets A-C, wherein the lower part is handling the sub-nets D and E. The lower part is acting like a conventional switch, wherein the upper part operates as follow. From slot five to slot seven on, only sub-net A may transmit to sub-nets B and C, while from slots eight to ten only sub-net C is allowed to transmit frames to sub-nets A and B.

After slot ten the matrix of the switch is further divided. In particular sub-net C is decoupled. From slot eleven onwards, transmissions from sub-net C are contained in sub-net C. To save memory, no further protection is provided in the sub-cluster consisting of sub-net A and B from slot eleven onwards. However, at slot twenty, also these sub-nets A and B are decoupled. As an extension to this, more than one simplified protocol engine may be added to the intelligent star coupler. This would enable more than one sub-cluster to be further sub-divided and protected in the dynamic segment progresses.

Please note that FlexRay allows an active star coupler to remove part of the beginning of transmission while passing it on. This is still true for the intelligent star coupler, at least if only one other active star is present in the channel.

Thus the invention provides an intelligent star coupler capable of activating more than one input branch within one time slot. Thereby, parallel transmissions are possible. This will increase the bandwidth.

1. Star coupler connected to a plurality of nodes within an automotive network using a time triggered protocol on a time slot basis, wherein the information flow within this network is based on a predetermined communication schedule determining which node may transmit in a predetermined time slot, wherein the star coupler comprises a switch having a plurality of input branches and output branches, wherein a branch may be connected to at least one node, a switch controller is provided for controlling the switch, further comprising means for deriving knowledge about the protocol timing, which knowledge is used for selectively forward incoming data in a certain time slot to at least one predetermined output branch.

2. Star coupler according to claim 1, wherein the switch may switch two or more inputs branches of the star coupler during a single time slot in parallel to two or more output branches.

3. Star coupler according to claim 1, wherein the switch may switch depending on the communication schedule each input branch to one or multiple output branches of the star coupler.

4. Star coupler according to claim 1, wherein the star coupler comprises a protocol engine for decoding communication elements within communication data and for deriving a position within the cluster communication schedule.

5. Star coupler according to claim 1, wherein the protocol engine is coupled to one output branch, wherein in case of outputting data to the same branch the respective output branch is disabled by a switching means.

6. Star coupler according to claim 1, wherein the protocol engine is coupled to an additional output branch of the switch having matrix an N×(N+1)matrix to be able to connect each of the output branches with the protocol engine.

7. Star coupler according to claim 1, wherein the star coupler comprises activity detecting units at the input branches for detecting data traffic on a certain input branch, wherein the activity detecting units are coupled to the switch controller for providing activity information, which is used for controlling the switch.

8. Star coupler according to claim 7, wherein the activity information is used for controlling the switch as long as a communication schedule is not established.

9. Star coupler according to claim 1, wherein the star coupler comprises at least one bit reshaping unit, which may be arranged at an input branch before or after the activity detection unit or at the output branch for regenerating communications elements.

10. Star coupler according to claim 1, wherein the star coupler comprises a communication schedule unit comprising information, which input branch needs to be connected to which output branch for a predetermined time slot and/or information in which time slots the activity detection units are to be used.

11. Star coupler according to claim 1, wherein the switch is realized as an analogous crossbar switch or a digital crossbar switch using a clock, wherein a digital crossbar switch is used in combination with a FIFO-unit, wherein the bit reshaping units are arranged then before the switch.

12. Star coupler according to claim 1, wherein a memory switch is used including a memory for storing all inputted data and reading the output data.

13. Star coupler according to claim 1, wherein a switch is assigned to a single communication channel, wherein in case of multiple channels within the network each channel is connected to one switch, wherein the protocol engine, the communication schedule unit and the switch controller -are coupled to the multiple switches for controlling the multiple switches.

14. Star coupler according to claim 1, wherein the FlexRay protocol is used for communicating within the network.

15. Star coupler according to claim 14, wherein the FlexRay protocol includes a static protocol segment and a dynamic protocol segment, wherein during the dynamic protocol segment of the FlexRay protocol the star coupler is controlled as an active star coupler, without using the multiple assignment of input branches to output branches, wherein a sub-net connected to the star coupler starting a transmission is served first and the input branch of the first transmitting sub-net is connected to all other subnet-output branches.

16. Star coupler according to clam 14, wherein the FlexRay protocol includes a static protocol segment and a dynamic protocol segment, wherein during the dynamic protocol segment of the FlexRay protocol the protocol engine of the star coupler observes the received traffic for recognizing the position within the communication schedule, wherein based on this observation and the predetermined communication schedule only the input branch determined in the current slot is allowed to transmit.

17. Star coupler according to claim 14, wherein the FlexRay protocol includes a static protocol segment and a dynamic protocol segment, wherein during the dynamic protocol segment of the FlexRay protocol the protocol engine of the star coupler observes the received traffic for recognizing the position within the communication schedule, wherein when an input branch is transmitting in contrary to the predetermined communication schedule this input branch is blocked by the protocol engine for the remaining dynamic segment within the current cycle.

18. Star coupler according to claim 14, wherein the FlexRay protocol includes a static protocol segment and a dynamic protocol segment, wherein during the dynamic protocol segment of the FlexRay protocol the protocol engine of the star coupler is determining the position within the communication schedule, wherein depending on the communication needs between the input branches the switch is controlled to decouple one or a part of the input branches from being synchronized with the remaining input branches for allowing a direct forwarding of data in between a sub-net connected to the one decoupled input branch or between connected nodes or sub-nets of decoupled input branches during the dynamic protocol segment.

19. Star coupler according to claim 1, wherein the switching of the switch is performed based on a slot number and/or a cycle number.

20. Network comprising a cluster including at least one node, the network is operating on a time triggered basis using time slots, wherein a plurality of nodes within the cluster is coupled to a star coupler as claimed in claim 1.

21. Method for communicating between nodes within a network using a time triggered protocol on a time slot basis, wherein the nodes are coupled to a star coupler, comprising:
receiving input data at an input branch of the star coupler;
decoding communication elements within the data and deriving a position within a communication schedule from the communication elements;
providing the communication schedule to a switch controller;
controlling a switch having a plurality of input branches and output branches on a time slot basis, wherein the switch may depending on the switch controller connect each input branch to one or multiple output branches, wherein a plurality of input branches may be active within the same time slot.
